(19) United States
(12) Patent Application Publication
(10) Pub. No.: US 2007/0271755 A1
(43) Pub. Date: Nov. 29, 2007

(54) Tool for aligning work pieces

(76) Inventor: Norman Gilbert, Fort McMurray (CA)

Correspondence Address: SUZANNAH K. SUNDBY, SMITH, GAMBRELL & RUSSEL, LLP, 1850 M STREET NW #800, WASHINGTON, DC, 20036, US

(21) Appl. No.: 11/440,138

(22) Filed: May 25, 2006

(51) Int. Cl. B25B 27/14

(52) U.S. Cl. 29/271

(57) ABSTRACT

A tool comprising a first portion and a second portion, the first and second portions being connected by means of an off-set connecting portion, wherein the first and second portions are generally perpendicular to each other. The tool is of particular use in aligning work pieces, for example in the field of pipe fitting, and the connecting portion preferably forms an open gap between the first and second portions to allow for protruding edges of work pieces.

### FIELD OF THE INVENTION

The present invention relates to tools, and more particularly to tools for aligning work pieces. The present invention is of particular application in the field of pipe fitting but has application in many other fields.

### BACKGROUND OF THE INVENTION

In many fields and industries, it is desirable to align discrete work pieces to enable their modification or manipulation. As an example, pipe fitters often require the alignment of a pipe section and a flange, to enable them to weld the two pieces together.

Referring to FIG. 1, a prior art carpenter's square 50 is the commonly employed tool used by pipe fitters when attempting to ensure proper alignment of a pipe section 12 and a flange 14. Given that the flange 14 is provided with a protruding edge or lip 16, however, the square 50 cannot rest flat against the outside surface of the pipe 12 when it is placed flat against the flange 14 face.

To align the pipe 12 and flange 14 using a carpenter's square 50, a pipe fitter first places a gap rod (not shown) between the pipe 12 end and the flange 14, ensures the inside diameter of the flange 14 measures the same as the inside diameter of the pipe 12, and then “tack welds” the flange 14 to the pipe 12. The short arm of the square 50 is then placed flat against the face of the flange 14, and the long arm of the square 50 is moved as close to the pipe 12 as the protruding edge 16 of the flange 14 will allow. Two measurements are then taken between the long arm of the square 50 and the outside surface of the pipe 12, using a measuring tape and level (not shown), resulting in measured distances a and b; if the measured distances a, b are the same, the pipe fitter then applies a further tack weld. The pipe 12 is then rotated 180 degrees, the square 50 is again used to enable two measurements, as above, and a further tack weld is applied. After this second tack weld, the pipe 12 is rotated 90 degrees, measured and tacked as above, and then the pipe 12 is rotated a final 180 degrees to enable a final set of measurements and tacking.

It has been found that this method, using a carpenter's square 50, is not only undesirably time-consuming, but it also does not provide a desirable degree of alignment accuracy, the accuracy depending primarily on the experience of the pipe fitter rather than the tools at their disposal. In addition, it would be difficult in most cases for a single pipe fitter to simultaneously take measurements, hold the square 50 in place, and tack weld the work pieces 12, 14, and the common method accordingly usually requires a second person.

The issue of alignment accuracy is of paramount importance, as misaligned pipe-flange connections can result in early fatigue of gaskets at the connections, possibly resulting in leakage of toxic and caustic materials being channeled by the pipes. For example, hydrogen sulfide gas is often transported using flanged pipe systems, and if leaked this gas can have fatal consequences with only minimal exposure. A flange which is not squared properly to the pipe can result in uneven pressure on the gasket, and increased risk of failure. Where the pipe system is being used to transport steam, any substantial leak can be observed during cold weather, but leaks are not readily observable during the warmer weather. If alignment problems are not addressed early on, the problem can intensify, resulting in thousands if not millions of dollars in down time for repairs of the pipe system, and in the most extreme cases can result in gasket blow-out or severe personal injuries to personnel.

Flanges are used with pipe systems in many contexts, including the oil and gas industry, paper mills, and power plants, and properly aligned flanges can potentially save companies millions of dollars, while helping to ensure safe environmental conditions.

What are needed, therefore, are means to ensure precise alignment of work pieces, to enable proper sealing at the connection point, preferably requiring less time and personnel. In fields other than pipe fitting, the consequences of misaligned work pieces might be equally severe, and some means are required to properly align work pieces.

### SUMMARY OF THE INVENTION

The present invention accordingly seeks to provide means to enable a person to align two work pieces and enable their manipulation or modification, eliminating the need for additional personnel and a time-consuming measurement process.

According to a first aspect of the present invention, then, there is provided a tool comprising:
a first portion having a first long axis;
a second portion having a second long axis; and
an off-set connecting portion connecting the first and second portions;
wherein the first long axis is generally perpendicular to the second long axis.

According to a second aspect of the present invention there is provided a tool for enabling relative positioning of work pieces comprising:
a first portion having a first edge;
a second portion having a second edge; and
a connecting portion connecting the first and second portions;
wherein the first edge is generally perpendicular to the second edge; and
wherein the connecting section is configured to form an open gap between at least a part of the first and second edges.

According to a third aspect of the present invention there is provided a tool for aligning work pieces comprising:
a first portion having a first edge;
a connecting portion connected to the first portion and angled away from the first edge; and
a second portion connected to the connecting portion and having a second edge generally perpendicular to the first edge, the first and second edges facing each other.

In exemplary embodiments of the present invention, the connecting portion preferably comprises: a first segment disposed at an angle to the first portion and connected thereto; and a second segment generally parallel to the first portion, the second segment connected at one end to the first segment and connected at an opposite end to the second portion. In a preferred embodiment, the connecting portion comprises: a first segment disposed at a 45 degree angle to the first portion and connected thereto; and a second segment generally parallel to the first portion, the second segment connected at one end to the first segment and connected at an opposite end to the second portion.

The connecting portion may also be rounded to form an open gap between at least a part of the first and second portions. In one exemplary embodiment, the connecting portion comprises: a first bend adjacent a first end thereof, the first end connected to the first portion; and a second and generally opposite bend spaced from the first bend; such that the first and second bends form an open gap between at least a part of the first and second portions.

In exemplary embodiments, the first portion may comprise a measurement scale, the second portion may comprise a measurement scale, or the first and second portions may each comprise a measurement scale. The first and second portions preferably have facing but generally perpendicular edges that are generally straight edges.

The connecting portion preferably forms an open gap between the first and second portions sized to receive at least part of a work piece. In preferred embodiments, the first portion is for providing an alignment edge for a first work piece, the second portion is for providing an alignment edge for a second work piece, and the connecting portion forms an open gap between the first and second portions sized to receive a protruding edge of the second work piece.

In embodiments of the tool for aligning pipe sections and flanges, for example for welding same together, the first portion is preferably for providing an alignment edge for a pipe section, the second portion is preferably for providing an alignment edge for a flange to be connected to the pipe section, and the connecting portion preferably forms an open gap between the first and second portions sized to receive a protruding edge of the flange. In embodiments of the tool for aligning two steel plates, the first portion is preferably for providing an alignment edge for a first steel plate, the second portion is preferably for providing an alignment edge for a second steel plate to be connected to the first steel plate, and the connecting portion preferably forms an open gap between the first and second portions sized to receive a protruding edge of the second steel plate. In embodiments of the tool for aligning pipe sections and pipe caps, the first portion is preferably for providing an alignment edge for a pipe section, the second portion is preferably for providing an alignment edge for a pipe cap of greater diameter than the pipe section and to be connected to the pipe section, and the connecting portion preferably forms an open gap between the first and second portions sized to receive a protruding part of the pipe cap.

As can be seen, a tool according to the present invention can help to ensure proper alignment of flanges in pipe systems, resulting in reduced maintenance, increased performance life of equipment (given reduced wear on bearings, pump shafts, flanges and gaskets), reduced risk of oil or toxin leakage from the system into the environment, and consequent enhancement of personnel safety. In addition, the risk of explosions is reduced where flammable materials are being transported by the pipe system.

As will be seen in the following, using a tool according to the present invention can reduce the time required to fit a flange to a pipe, and also reduce personnel requirements. The tool is also flexible enough in its application to allow use no matter what the pipe orientation, and it can be inexpensively manufactured and accordingly sized for any desired application.

A detailed description of exemplary embodiments of the present invention is given in the following. It is to be understood, however, that the invention is not to be construed as limited to these embodiments.

### BRIEF DESCRIPTION OF THE DRAWINGS

In the accompanying drawings, which illustrate exemplary embodiments of the present invention:

FIG. 1 is a prior art carpenter's square currently used to fit a flange to a pipe section;

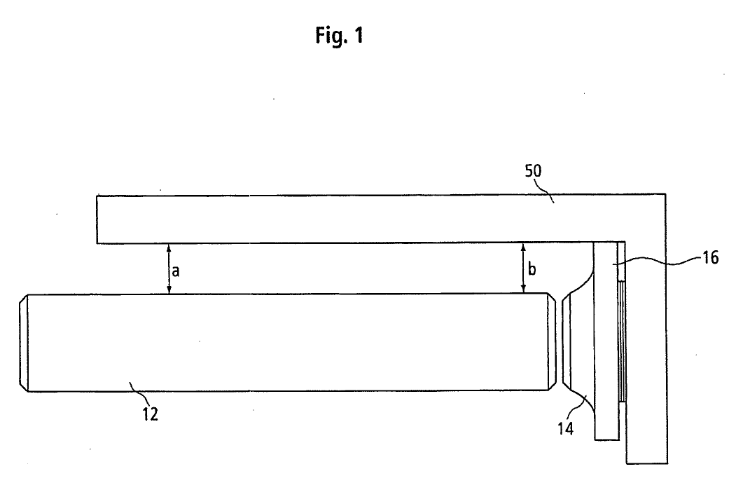

FIG. 2 is a side elevation view of one embodiment of a tool according to the present invention;

FIG. 3 is a side elevation view of a tool having measurement scales on the first and second portions of the tool;

FIG. 4 is a side elevation view of another embodiment of a tool according to the present invention, namely one where the connecting portion is curved;

FIG. 5 is a side elevation view of yet another embodiment of a tool according to the present invention, namely one where the connecting portion comprises right angles to form the off-set;

FIGS. 6a and 6b are side elevation and top plan views of a tool during use in fitting a flange to a pipe section;

FIG. 7 is a side elevation view showing how a tool according to the present invention can be used to align two plates of steel;

FIGS. 8 is a side elevation view showing how a tool according to the present invention can be used to align a pipe section and pipe cap;

FIG. 9 is a top plan view of three tools, illustrating that the tool can be sized for diverse applications;

FIG. 10 is a series of side elevation views of pipes in different orientations, illustrating the utility of the tool given diverse pipe orientations;

FIGS. 11 provides a visual comparison of a properly aligned flange and an improperly aligned flange; and

FIG. 12 is a simplified illustration of a motor-driven pump apparatus employing flanged pipe connections.

### DETAILED DESCRIPTION OF EXEMPLARY EMBODIMENTS

Referring now in detail to the accompanying drawings, there are illustrated exemplary embodiments of a tool according to the present invention, generally referred to by the numeral 10.

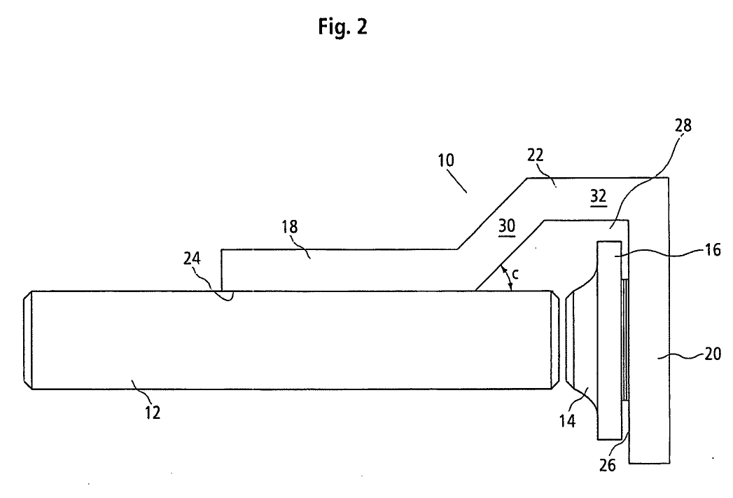

Referring now in detail to FIG. 2, there is illustrated a first embodiment of the present invention, illustrated in use as means for aligning a pipe 12 and flange 14. The tool 10 comprises a first portion 18 having a first edge 24, a second portion 20 having a second edge 26, and a connecting portion 22, the first and second edges 24, 26 for positioning the pipe 12 and flange 14 against, respectively. As can be seen, the flange 14 comprises a protruding edge 16 that would render a traditional square incapable of resting flat against both the face of the flange 14 and the outside surface of the pipe 12. The tool 10 addresses this problem by means of a gap 28, formed in part by the shape of the connecting portion 22. The connecting portion 22 comprises a first segment 30 and a second segment 32. The first segment 30 connects at one end to the first portion 18 and is disposed at an angle c to the long axis of the first portion 18 away from the first edge 24; in this embodiment, the angle is 45 degrees. Having extended a distance away from the first edge 24, the first segment 30 is then connected at an opposite end to the second segment 32, which is oriented generally parallel to the first portion 18 and connects in turn to the second portion 20. The connecting portion 22 serves to off-set part of the edge of the tool 10 facing the pipe 12, with the effect that the gap 28 is formed and can receive the protruding edge 16 of the flange 14 and allow the outside surface of the pipe 12 to contact the first edge 24. By doing so, the perpendicular orientation of the first and second edges 24, 26 provides the means for ensuring a proper alignment of the pipe 12 and flange 14.

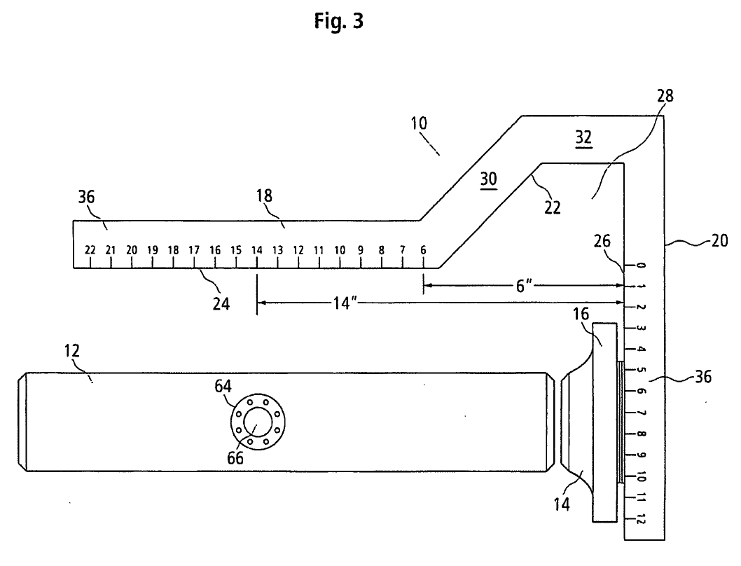

Referring now to FIG. 3, a modification of the first embodiment is illustrated. In this modification, measurement scales 36 are provided on both the first and second portions 18, 20 adjacent the first and second edges 24, 26, respectively. In many cases, a pipe 12 will have more than one flange connection, and the connections must be at a precise distance apart. While a measuring tape is currently employed for this purpose, the tool 10 as illustrated in FIG. 2 demonstrates how this can be eliminated by providing measurement scales 36 on the tool 10 itself. As can be seen, there is a second flange connection 64 on the pipe 12. If the face of the flange 14 must be precisely 14 inches from the centre 66 of the second flange connection 64, for example, this measurement is easily made with the modified tool 10.

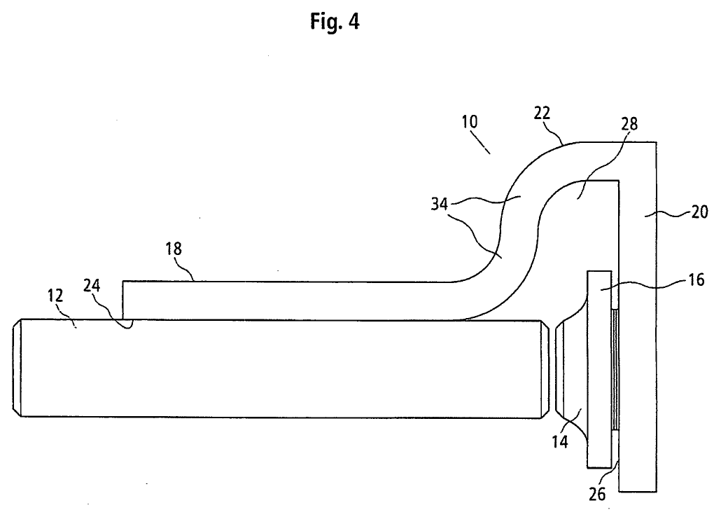

FIG. 4 illustrates another embodiment of a tool 10 according to the present invention. In this embodiment, the connecting portion provides the desired off-set by means of bends 34 rather than straight, angled segments. With two 90 degree bends 34, the connecting portion 22 is able to provide the necessary gap 28 to accommodate the protruding edge 16 of the flange 14.

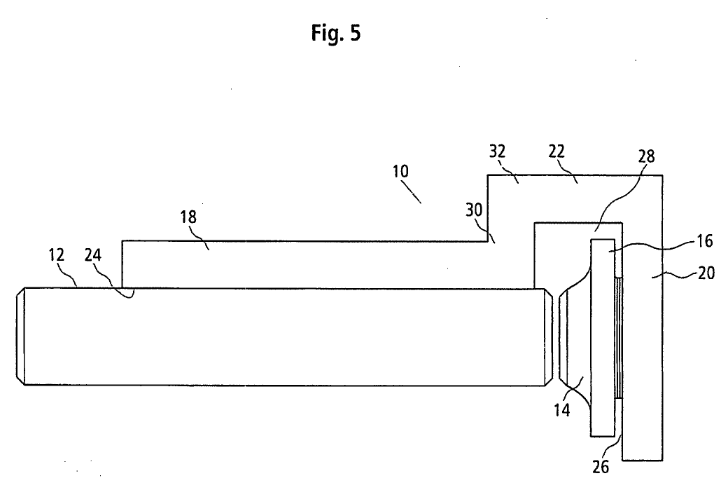

FIG. 5 illustrates yet another embodiment of a tool 10 according to the present invention, this time with a connecting portion 22 comprising only right angles. Unlike the 45 degree orientation of the first segment 30 illustrated in FIGS. 2 and 3, the first segment 30 in this alternative embodiment is disposed at a 90 degree angle to the long axis of the first portion 18, with the second segment 32 parallel to the first portion 28. Again, the desired gap 28 is formed.

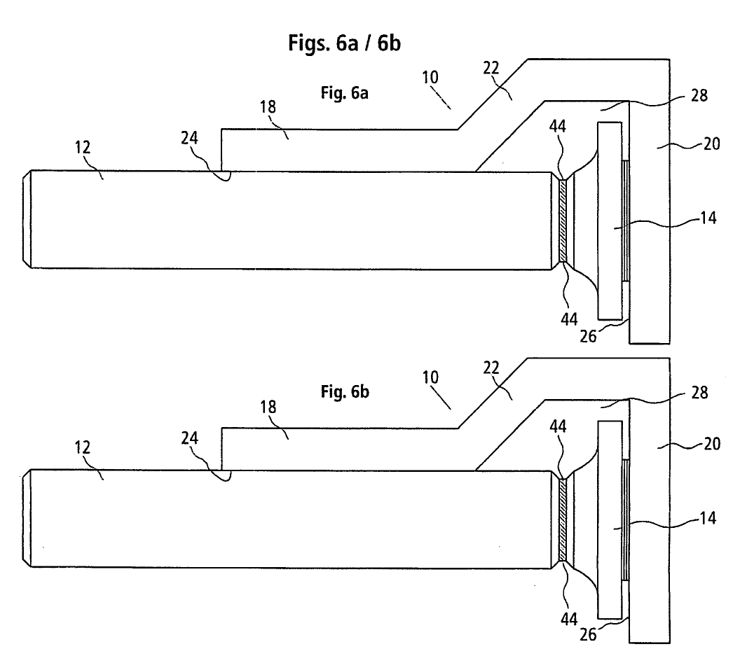

The utility and advantages of the present invention will become clear in the following. To recall, the current, standard method for aligning and connecting a flange and pipe involves a lengthy process with numerous rotations of the pipe 12 and the requirement for at least a second person. Referring now to FIGS. 6a and 6b, the tool 10 provides a far simpler process. The pipe fitter would still place a gap rod between the flange 14 and the pipe 12 end, ensure that the inside diameter of the flange 14 measures the same as the inside diameter of the pipe 12, and tack weld the flange 14 to the pipe 12 with a tack 44, as in the standard method. However, the pipe fitter would then place the first edge 24 of the tool 10 against the pipe 12 at a point adjacent the tack 44, shift the flange 14 until the face is flat against the second edge 26 of the tool 10, and provide a second tack 44. Rather than rotating the pipe 12, the tool 10 itself can then be rotated around the pipe 12 at 90 degree spacing, repeating the tacking. The pipe 12 would not need to be rotated after the first tack, and no measuring tape would be required. In addition, no second person should be required when using the tool 10 in this manner. As can clearly be seen, then, there is significant time savings in this process, eliminating the measuring tape step enhances accuracy, and personnel requirements have been reduced by half.

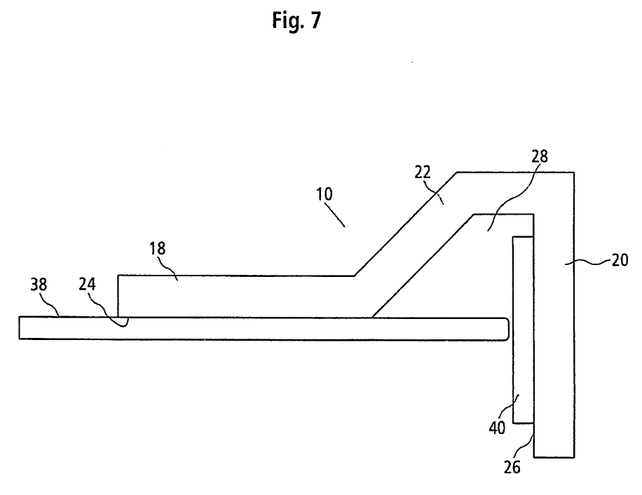

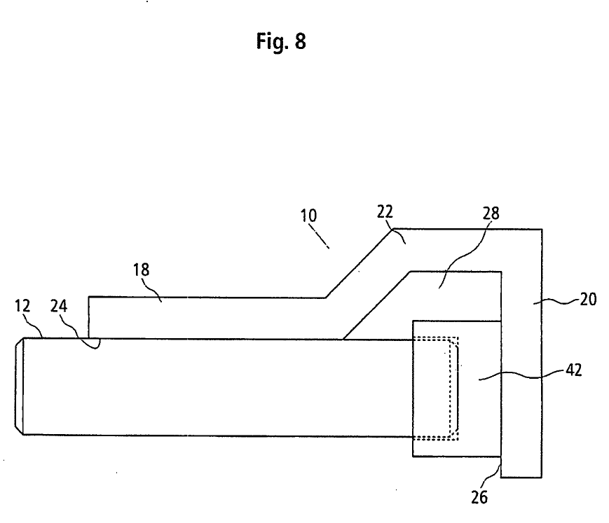

As can be seen in FIGS. 7 and 8, the tool 10 can be used in other applications than pipe-to-flange welded connections. Turning to FIG. 7, where it is desired to square a first steel plate 38 to a second steel plate 40, the first steel plate 38 can be placed flat against the first edge 24 of the first portion 18, and the second steel plate 40 can be similarly placed flat against the second edge 26 of the second portion 20, enabling welding of the plates 38, 40 or any other desired activity. FIG. 8 illustrates the utility of the tool 10 in squaring a pipe cap 42 to the pipe 12, ensuring precise alignment.

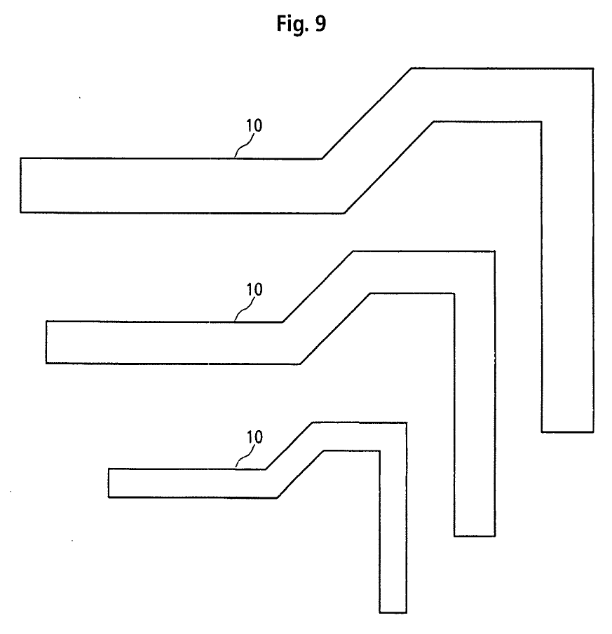

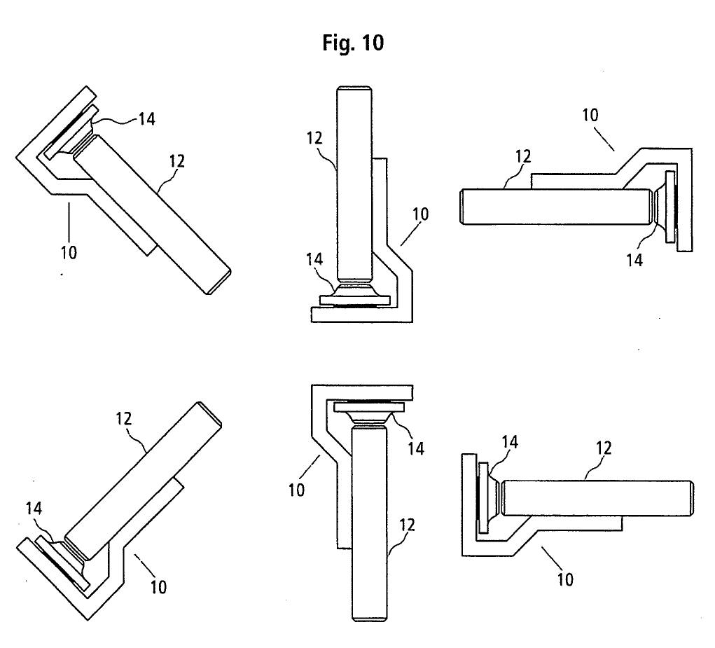

A tool 10 according to the present invention can be of any desired size or configuration, as dictated by the specific application. For example, tools 10 can be manufactured to any desired size, as illustrated in FIG. 9, given different work piece sizes. Also, as mentioned above, the tool 10 can be employed no matter what the pipe 12 orientation; as can be seen in FIG. 10, the tool 10 has utility no matter how the pipe 12 is positioned.

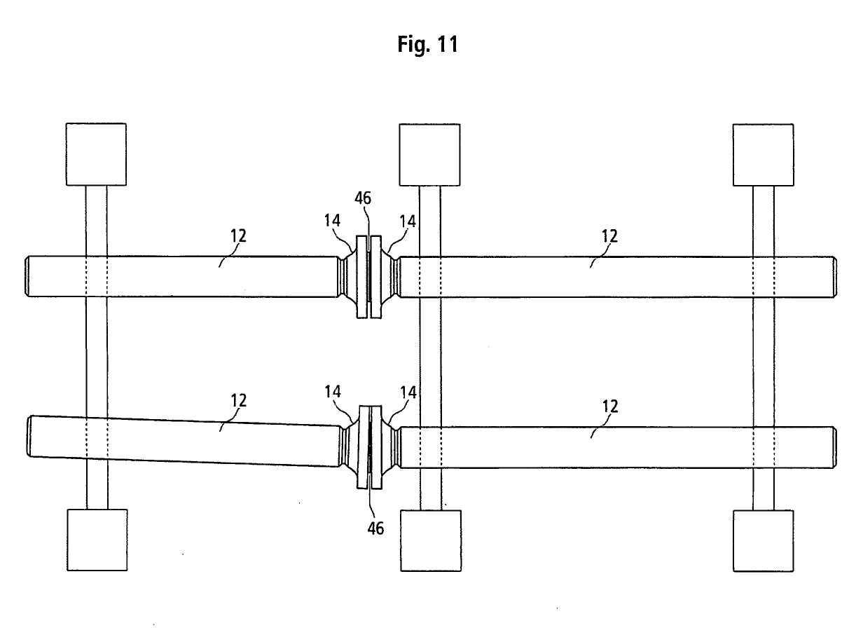

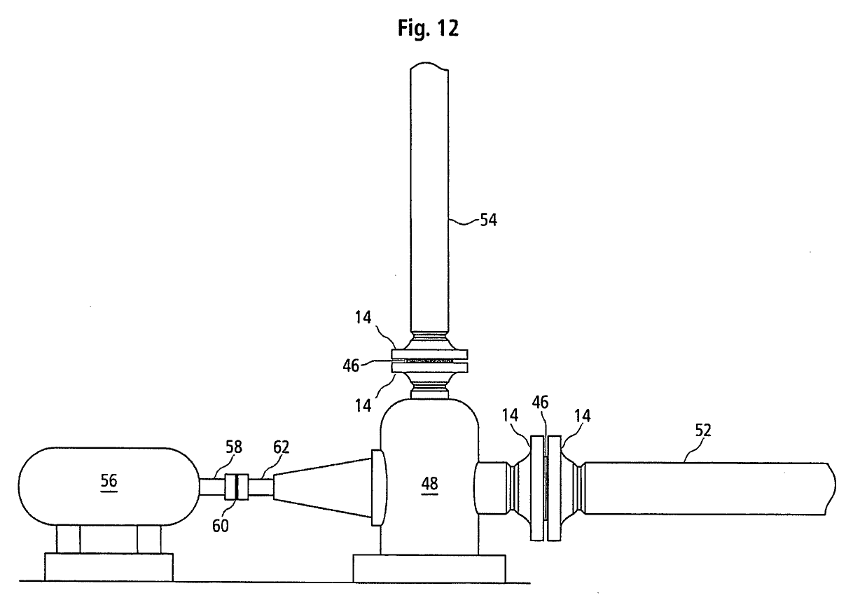

As stated above, misalignment of a flange connection can have a significant impact on a pipe system. As illustrated in FIG. 11, misalignment of the flange connection can result in misaligned pipe sections 12, which can have disastrous consequences should a gasket 46 fail. FIG. 12 illustrates a simplified pump system, where a motor 56 powers a pump 48 via a motor shaft 58, couplings 60, and a pump shaft 62. While the intake pipe 52 is properly aligned, the flange 14 of the outlet pipe 54 is misaligned, with the result that the gasket 46 is under uneven pressure and is at increased risk of rupture. The present invention would help to ensure that such misalignment does not take place.

While particular embodiments of the present invention have been described in the foregoing, it is to be understood that other embodiments are possible within the scope of the invention and are intended to be included herein. It will be clear to any person skilled in the art that modifications of and adjustments to this invention, not shown, are possible without departing from the spirit of the invention as demonstrated through the exemplary embodiments. For example, there may be specific industrial applications that would require a non-perpendicular alignment of two work pieces, and the present invention could obviously be modified to embody such an alternative form. As a further example, the connecting portion could simply be a straight length angled from the first portion and directly connecting the ends of the first and second portions, excluding any segment parallel to the first portion. The invention is therefore to be considered limited solely by the scope of the appended claims.

Embodiments of the invention in which an exclusive property or privilege is claimed are defined as follows:

1. A tool comprising:
a first portion having a first long axis;
a second portion having a second long axis; and
an off-set connecting portion connecting the first and second portions;
wherein the first long axis is generally perpendicular to the second long axis.

2. A tool for enabling relative positioning of work pieces comprising:
a first portion having a first edge;
a second portion having a second edge; and
a connecting portion connecting the first and second portions;
wherein the first edge is generally perpendicular to the second edge; and
wherein the connecting section is configured to form an open gap between at least a part of the first and second edges.

3. A tool for aligning work pieces comprising:
a first portion having a first edge;
a connecting portion connected to the first portion and angled away from the first edge; and
a second portion connected to the connecting portion and having a second edge generally perpendicular to the first edge, the first and second edges facing each other.

4. The tool of any one of claims 1 to 3 wherein the connecting portion comprises:
a first segment disposed at an angle to the first portion and connected thereto; and
a second segment generally parallel to the first portion, the second segment connected at one end to the first segment and connected at an opposite end to the second portion.

5. The tool of any one of claims 1 to 3 wherein the connecting portion comprises:
a first segment disposed at a 45 degree angle to the first portion and connected thereto; and
a second segment generally parallel to the first portion, the second segment connected at one end to the first segment and connected at an opposite end to the second portion.

6. The tool of any one of claims 1 to 3 wherein the connecting portion is rounded to form an open gap between at least a part of the first and second portions.

7. The tool of any one of claims 1 to 3 wherein the connecting portion comprises:
a first bend adjacent a first end thereof, the first end connected to the first portion; and
a second and generally opposite bend spaced from the first bend;
such that the first and second bends form an open gap between at least a part of the first and second portions.

8. The tool of any one of claims 1 to 3 wherein the first portion comprises a measurement scale.

9. The tool of any one of claims 1 to 3 wherein the second portion comprises a measurement scale.

10. The tool of any one of claims 1 to 3 wherein the first and second portions each comprise a measurement scale.

11. The tool of any one of claims 1 to 3 wherein the first and second portions have facing but generally perpendicular edges that are generally straight edges.

12. The tool of any one of claims 1 to 3 wherein the connecting portion forms an open gap between the first and second portions sized to receive at least part of a work piece.

13. The tool of any one of claims 1 to 3 wherein the first portion is for providing an alignment edge for a first work piece, the second portion is for providing an alignment edge for a second work piece, and the connecting portion forms an open gap between the first and second portions sized to receive a protruding edge of the second work piece.

14. The tool of any one of claims 1 to 3 wherein the first portion is for providing an alignment edge for a pipe section, the second portion is for providing an alignment edge for a flange to be connected to the pipe section, and the connecting portion forms an open gap between the first and second portions sized to receive a protruding edge of the flange.

15. The tool of any one of claims 1 to 3 wherein the first portion is for providing an alignment edge for a first steel plate, the second portion is for providing an alignment edge for a second steel plate to be connected to the first steel plate, and the connecting portion forms an open gap between the first and second portions sized to receive a protruding edge of the second steel plate.

16. The tool of any one of claims 1 to 3 wherein the first portion is for providing an alignment edge for a pipe section, the second portion is for providing an alignment edge for a pipe cap of greater diameter than the pipe section and to be connected to the pipe section, and the connecting portion forms an open gap between the first and second portions sized to receive a protruding part of the pipe cap.
